(19) United States
(12) Patent Application Publication
(10) Pub. No.: US 2026/0014694 A1
(43) Pub. Date: Jan. 15, 2026

(54) CLUSTER TOOL

(71) Applicant: Tokyo Electron Limited, Tokyo (JP)

(72) Inventors: Norihiko AMIKURA, Miyagi (JP); Taisei SEGUCHI, Miyagi (JP)

(73) Assignee: Tokyo Electron Limited, Tokyo (JP)

(21) Appl. No.: 19/335,017

(22) Filed: Sep. 22, 2025

Related U.S. Application Data
(63) Continuation of application No. PCT/JP2024/010445, filed on Mar. 18, 2024.

(30) Foreign Application Priority Data
Mar. 29, 2023 (JP) 2023-054316

(51) Int. Cl. B25J 5/02; B25J 9/12; B25J 11/00; B25J 15/00

(52) U.S. Cl. CPC B25J 5/02; B25J 9/123; B25J 11/005; B25J 15/0014

(57) ABSTRACT

A cluster tool includes a plasma processing apparatus and a mobile replacement apparatus. The plasma processing apparatus includes a plasma processing module having a first surface and a second surface, and a vacuum transferer connected to the plasma processing module via the first surface. The plasma processing module includes a support member and a consumable ring. The mobile replacement apparatus includes a ring storage portion and a ring replacement robot configured to transfer the consumable ring between the ring storage portion and the plasma processing module, the ring replacement robot transferring the consumable ring along a first direction orthogonal to the second surface, and a slide mechanism that slides the ring replacement robot along a second direction orthogonal to the first direction.

### CROSS-REFERENCE TO RELATED APPLICATIONS

This application is a bypass continuation application of international application No. PCT/JP2024/010445 having an international filing date of Mar. 18, 2024 and designating the United States, the international application being based upon and claiming the benefit of priority from Japanese Patent Application No. 2023-054316, filed on Mar. 29, 2023, the entire contents of each are incorporated herein by reference.

### TECHNICAL FIELD

The present disclosure relates to a cluster tool.

### BACKGROUND

PTL 1 discloses a component replacement system including a component storage apparatus that stores a consumable component before use, and a component replacement apparatus that connects a processing apparatus to the component storage apparatus and replaces a consumable component after use in the processing apparatus with the consumable component before use in the component storage apparatus.

### CITATION LIST

### Patent Documents

PTL 1: JP2021-176173A

### SUMMARY

A technique according to the disclosure provides a cluster tool that can properly transfer a consumable component to a plasma processing module regardless of a docking error between the plasma processing module and a mobile replacement apparatus.

An aspect of the disclosure provides a cluster tool including: a plasma processing apparatus, and a mobile replacement apparatus, in which the plasma processing apparatus includes a plasma processing module having a first surface and a second surface, and a vacuum transfer module connected to the plasma processing module via the first surface, and the plasma processing module includes a support member having a substrate support surface and a ring support surface, and a consumable ring disposed on the ring support surface, and the mobile replacement apparatus includes a ring storage portion configured to store the consumable ring, a ring replacement robot configured to transfer the consumable ring along a first direction between the ring storage portion and the plasma processing module, the first direction being orthogonal to the second surface when the mobile replacement apparatus is connected to the plasma processing module, and a slide mechanism configured to slide the ring replacement robot along a second direction orthogonal to the first direction.

According to the disclosure, it is possible to provide a cluster tool that can properly transfer a consumable component to a plasma processing module regardless of a docking error between the plasma processing module and a mobile replacement apparatus.

### BRIEF DESCRIPTION OF DRAWINGS

FIG. 1 is a plan view illustrating an example of a configuration of a substrate processing system according to an embodiment.

FIG. 2 is a vertical sectional view illustrating an example of a configuration of a plasma processing module.

FIG. 3 illustrates disposition of a lift pin.

FIG. 4 is a vertical sectional view illustrating an example of a configuration of a mobile replacement apparatus.

FIG. 5 is a perspective view illustrating an example of a configuration of a component transfer robot.

FIG. 6 is a perspective view illustrating an example of a configuration of a slide mechanism.

FIG. 7 is a flow chart illustrating a flow of a component replacement sequence according to the embodiment.

FIG. 8 illustrates positional misalignment between the component transfer robot and a support member.

FIG. 9 illustrates a method in the related art for correcting the positional misalignment illustrated in FIG. 8.

FIG. 10 illustrates a method according to the embodiment for correcting the positional misalignment illustrated in FIG. 8.

FIG. 11 is a perspective view illustrating an example of a configuration of a component transfer robot according to another embodiment.

FIG. 12 illustrates another method for correcting the positional misalignment illustrated in FIG. 8.

FIG. 13 illustrates another method for correcting the positional misalignment illustrated in FIG. 8.

### DETAILED DESCRIPTION

A plasma processing apparatus that performs plasma processing such as an etching process or post-processing on a semiconductor substrate (hereinafter referred to as a “substrate”) uses various consumable components such as a ring assembly. Such a consumable component is replaced with a new consumable component when an amount of consumption is larger than a predetermined amount of consumption.

Such replacement of the consumable component is performed using a component replacement apparatus connected to the plasma processing apparatus each time the consumable component is replaced, as also disclosed in PTL 1. However, PTL 1 does not consider misalignment in a rotational direction of the consumable component caused by positional misalignment between the plasma processing apparatus and the component replacement apparatus at the time of docking, and thus there is room for improvement in this respect.

A technique according to the disclosure has been made in view of the above-described circumstances and provides a cluster tool that can properly transfer a consumable component to a plasma processing module regardless of a docking error between the plasma processing module and a mobile replacement apparatus. Hereinafter, a plasma processing system according to an embodiment will be described with reference to the drawings. The same reference numerals will be given to elements having substantially the same functional configurations throughout the specification and the drawings, and redundant description thereof will be omitted.

### <Plasma Processing System>

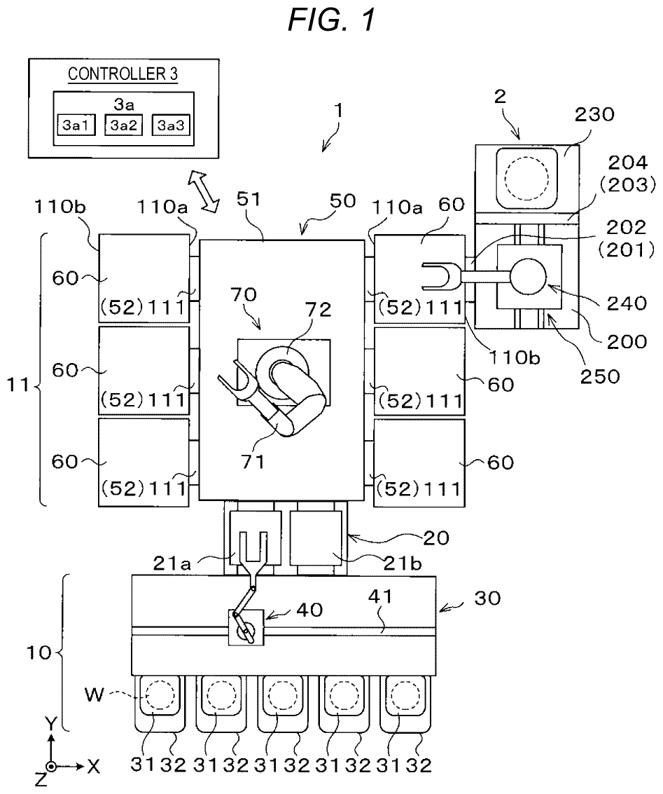

First, a configuration of the substrate processing system according to the present embodiment will be described. FIG. 1 is a plan view showing a schematic configuration of the plasma processing system of the present embodiment. The plasma processing system includes a plasma processing apparatus 1, a mobile replacement apparatus 2, and a controller 3. As illustrated in FIG. 1, the plasma processing system is a cluster tool that includes a plasma processing module 60 and a vacuum transfer module 50 (i.e., vacuum transferer), which will be described later. A wafer is an example of a substrate. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

As illustrated in FIG. 1, the plasma processing apparatus 1 has a configuration in which an atmospheric portion 10 and a reduced-pressure portion 11 (i.e., decompression portion) are integrally connected through a load-lock module 20. The atmospheric portion 10 includes an atmospheric module that processes and/or transfers a substrate W under an atmospheric atmosphere. The decompression portion 11 includes a decompression module (vacuum module) that processes and/or transfers the substrate W in a decompressed (vacuum) atmosphere.

The load-lock module 20 has a plurality of, for example, two load-lock chambers 21a and 21b (hereinafter, may be collectively referred to simply as the “load-lock chamber 21”) in the embodiment along an atmospheric transfer module 30 to be described later and the vacuum transfer module 50 to be described later. The load-lock chamber 21 is configured to temporarily hold the substrate W.

The load-lock chamber 21 is provided to establish communication, through a substrate transfer port, between an atmospheric transfer space of the atmospheric transfer module 30 to be described later of the atmospheric portion 10 and a vacuum transfer space of the vacuum transfer module 50 to be described later of the decompression portion 11. The load-lock chamber 21 is configured such that the inside thereof can be switched between an atmospheric atmosphere and a decompressed environment (vacuum state). That is, the load-lock module 20 is configured to appropriately transfer the substrate W between the atmospheric portion 10 in an atmospheric atmosphere and the decompression portion 11 in the decompressed environment. The substrate transfer port is openable and closable by a gate valve (not illustrated).

The atmospheric portion 10 includes the atmospheric transfer module 30 including a substrate transfer robot 40 to be described later therein, and load ports 32 placed with hoops 31 (i.e., cassettes or front opening unified pods (FOUPs)) capable of storing the substrates W. An orienter module (not illustrated) that adjusts an orientation of the substrate W in the horizontal direction, a storage module (not illustrated) that stores the substrates W, and the like may be provided adjacent to the atmospheric transfer module 30.

The atmospheric transfer module 30 includes a rectangular housing therein, and an interior of the housing is maintained in the atmospheric atmosphere. A plurality of, for example, five load ports 32 are disposed in parallel on one side surface forming a long side of the atmospheric transfer module 30 on a Y-axis negative direction side. The load-lock chambers 21a and 21b of the load-lock module 20 are disposed in parallel on the other side surface forming a long side of the atmospheric transfer module 30 on a Y-axis positive direction side.

The substrate transfer robot 40 that transfers the substrate W is provided inside the atmospheric transfer module 30. For example, the substrate transfer robot 40 is configured to move on a transfer path 41 extending in an X-axis direction and transfer the substrate W between the hoop 31 of the load port 32 and the load-lock chambers 21a and 21b of the load-lock module 20. A configuration of the substrate transfer robot 40 is not limited thereto.

The decompression portion 11 includes the vacuum transfer module 50 that transfers the substrate W therein, and the plasma processing module 60 that performs desired processing on the substrate W transferred from the vacuum transfer module 50. The inside of each of the vacuum transfer module 50 and the plasma processing module 60 can be maintained in a decompressed (vacuum) atmosphere. In the embodiment, a plurality of, for example, six plasma processing modules 60 and two load-lock chambers 21a and 21b are connected to one vacuum transfer module 50. The number and disposition of plasma processing modules 60 are not limited to the embodiment, and may be set as desired.

The vacuum transfer module 50 includes a housing 51 having a planar rectangular shape. The housing 51 has a substrate transfer port 52 to which the plasma processing module 60 to be described later is connected. The vacuum transfer space of the vacuum transfer module 50 communicates with the inside of the plasma processing module 60 through the substrate transfer port 52.

A transfer robot 70 that transfers the substrate W is provided inside the vacuum transfer module 50. The transfer robot 70 is an articulated robot including a plurality of, for example, three transfer arms 71. Each of the three transfer arms 71 is pivotable. The transfer arm 71 at a distal end holds and transfers the substrate W. The transfer arm 71 at the distal end is also referred to as a so-called end effector. The transfer arm 71 at a proximal end is pivotably attached to a base 72. In one embodiment, the transfer robot 70 is configured to transfer the substrate W between the load-lock module 20 and one or a plurality of plasma processing modules 60.

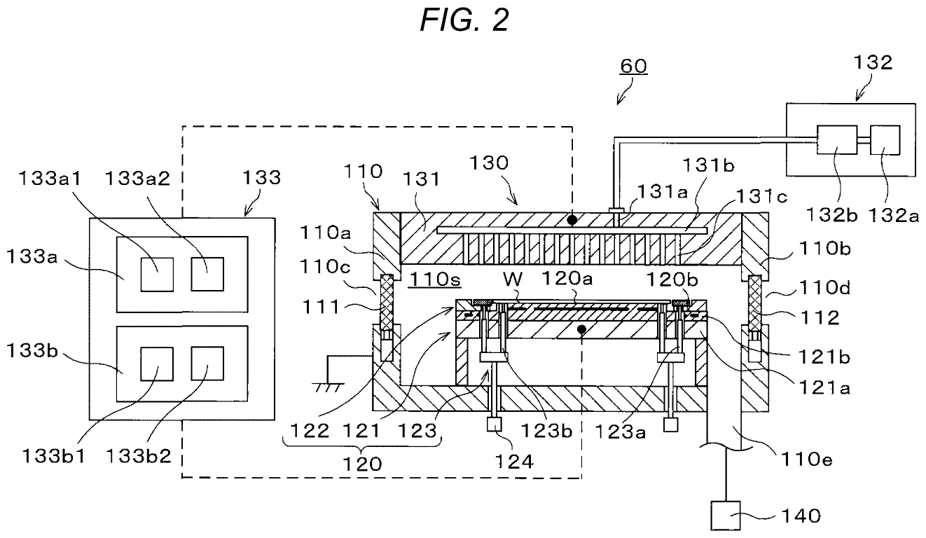

The plasma processing module 60 performs plasma processing such as an etching process on the substrate W. In one example, the plasma processing module 60 includes a plasma processing chamber 110, a support member 120, a plasma generator 130, and an exhaust system 140, as illustrated in FIG. 2.

The plasma processing chamber 110 has a plasma processing space 110s. The plasma processing chamber 110 (the plasma processing module 60) has a first surface 110a and a second surface 110b on a side opposite to the first surface 110a. A first opening 110c is formed in the first surface 110a, and the first opening 110c is connected to the vacuum transfer module 50 through the substrate transfer port 52. Accordingly, the plasma processing space 110s communicates with the vacuum transfer space through the first opening 110c and the substrate transfer port 52. A gate valve 111 is provided on the first surface 110a side, and the substrate transfer port 52 is openable and closable by the gate valve 111. A second opening 110d is formed in the second surface 110b, and the second opening 110d is connected to the mobile replacement apparatus 2 to be described later through a component transfer port 201 to be described later. A gate valve 112 is provided on the second surface 110b side, and the second opening 110d is openable and closable by the gate valve 112.

The support member 120 includes a main body 121, a ring assembly 122, and a lifter 123. The main body 121 has a central region 120a for supporting the substrate W and an annular region 120b for supporting the ring assembly 122. The annular region 120b of the main body 121 surrounds the central region 120a of the main body 121 in a plan view. The substrate Wis disposed on the central region 120a of the main body 121, and the ring assembly 122 is disposed on the annular region 120b of the main body 121 to surround the substrate W on the central region 120a of the main body 121. Accordingly, the central region 120a is also called a substrate support surface for supporting the substrate W, and the annular region 120b is also called a ring support surface for supporting the ring assembly 122.

In one embodiment, the main body 121 includes a base 121a and an electrostatic chuck 121b. The base 121a includes a conductive member. The conductive member of the base 121a may function as a lower electrode. The electrostatic chuck 121b is disposed on the base 121a. The electrostatic chuck 121b includes a ceramic member (not illustrated) and an electrostatic electrode (not illustrated) disposed in the ceramic member. The ceramic member has the central region 120a. In one embodiment, the ceramic member also has the annular region 120b. Other members that surround the electrostatic chuck 121b, such as an annular electrostatic chuck and an annular insulating member, may have the annular region 120b. In this case, the ring assembly 122 may be disposed on the annular electrostatic chuck or the annular insulating member, or may be disposed on both the electrostatic chuck 121b and the annular insulating member. In addition, at least one RF/DC electrode coupled to a radio frequency (RF) power source and/or a direct current (DC) power source may be disposed inside the ceramic member. In this case, at least one RF/DC electrode functions as the lower electrode. When a bias RF signal and/or DC signal is supplied to at least one RF/DC electrode, the RF/DC electrode is also referred to as a bias electrode. The conductive member of the base 121a and the at least one RF/DC electrode may function as a plurality of lower electrodes. Further, the electrostatic electrode may function as the lower electrode. Accordingly, the support member 120 includes at least one lower electrode.

The ring assembly 122 includes one or a plurality of annular members. In one embodiment, the one or more annular members include one or more edge rings and at least one cover ring. The edge ring is made of an electrically conductive material or an insulating material, and the cover ring is made of an insulating material. The edge ring is also called a focus ring. In the embodiment, the ring assembly 122 is a consumable ring that is an example of a consumable component to be replaced. Accordingly, the ring assembly 122 before use is stored in the mobile replacement apparatus 2 to be described later and replaced with the ring assembly 122 after use in the plasma processing chamber 110.

A plurality of lifters 123, for example three lifters 123 are disposed to correspond to through-holes formed in the main body 121. Each lifter 123 includes three ring lift pins 123a for moving the ring assembly 122 on the annular region 120b (ring support surface) in the vertical direction and three substrate lift pins 123b for moving the substrate W on the central region 120a (substrate support surface) in the vertical direction. The lifter 123 also includes an actuator 124 for moving the ring lift pins 123a and the substrate lift pins 123b in the vertical direction. The actuator 124 may be commonly disposed for the ring lift pins 123a and the substrate lift pins 123b, or may be independently disposed for the ring lift pins 123a and the substrate lift pins 123b.

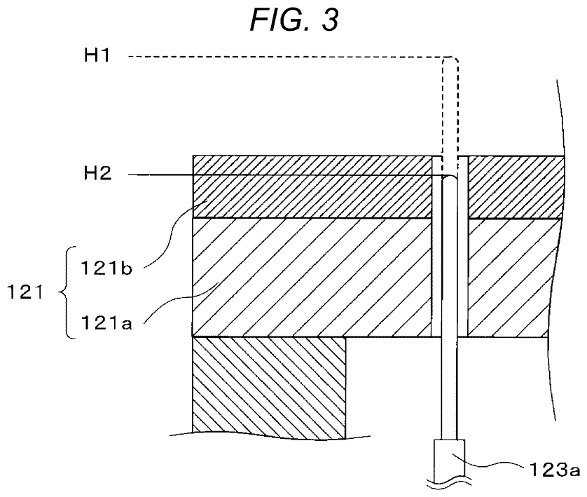

The actuator 124 moves each ring lift pin 123a between a transfer position H1 above the ring support surface and a standby position H2 below the ring support surface (see FIG. 3). At the transfer position H1, the ring assembly 122 is transferred between the transfer arms 71 of the transfer robot 70 and/or an end effector 241 of a component replacement robot 240 to be described later. The standby position H2 is a position where a distal end of the ring lift pin 123a does not protrude from the ring support surface. Accordingly, the actuator 124 moves the ring lift pin 123a along an axial direction (vertical direction) to lift and lower the ring assembly 122 on the electrostatic chuck 121b. Examples of the actuator include an electric actuator, an air cylinder, and a motor.

The support member 120 may include a temperature control module configured to adjust at least one of the electrostatic chuck 121b, the ring assembly 122, and the substrate W to a target temperature. The temperature control module may include a heater, a heat transfer medium, a flow path, or a combination thereof. A heat transfer fluid, such as brine or gas, flows through the flow path. In one embodiment, a flow path is formed inside the base 121a, and one or a plurality of heaters are disposed inside the ceramic member of the electrostatic chuck 121b. The support member 120 may also include a heat transfer gas supply configured to supply a heat transfer gas (backside gas) to a gap between a rear surface of the substrate W and an upper surface of the electrostatic chuck 121b.

The plasma generator 130 is configured to generate plasma from at least one processing gas supplied into the plasma processing space 110s. The plasma generator 130 includes a gas introduction unit, a gas supply 132, and a power source 133.

The gas introduction unit includes a shower head 131. The shower head 131 is disposed above the support member 120. In one embodiment, the shower head 131 constitutes at least a portion of a ceiling portion of the plasma processing chamber 110.

The shower head 131 is configured to introduce at least one processing gas from the gas supply 132 into the plasma processing space 110s. The shower head 131 includes at least one gas supply port 131a, at least one gas diffusion chamber 131b, and a plurality of gas introduction ports 131c. The processing gas supplied from the gas supply 132 to the gas supply port 131a passes through the gas diffusion chamber 131b and is introduced into the plasma processing space 110s from the plurality of gas introduction ports 131c. The shower head 131 includes at least one upper electrode. The gas introduction unit may include, in addition to the shower head 131, one or a plurality of side gas injectors (SGI) that are attached to one or a plurality of openings formed in a sidewall of the plasma processing chamber 110. In the embodiment, the shower head 131 may be an example of the consumable component to be replaced. Accordingly, the shower head 131 before use may be stored in the mobile replacement apparatus 2 to be described later and replaced with the shower head 131 after use in the plasma processing chamber 110.

The gas supply 132 may include at least one gas source 132a and at least one flow rate controller 132b. In one embodiment, the gas supply 132 is configured to supply at least one processing gas from each corresponding gas source 132a to the shower head 131 via each corresponding flow rate controller 132b. Each flow rate controller 132b may include, for example, a mass flow controller or a pressure-controlled flow rate controller. Further, the gas supply 132 may include at least one flow rate modulation device that modulates and/or pulses a flow rate of the at least one processing gas.

The power source 133 includes an RF power source 133a coupled to the plasma processing chamber 110 via at least one impedance matching circuit. The RF power source 133a is configured to supply at least one RF signal (RF power) to at least one lower electrode and/or at least one upper electrode. Accordingly, plasma is formed from the at least one processing gas supplied to the plasma processing space 110s. Supplying the bias RF signal to at least one lower electrode can generate a bias potential in the substrate W to attract an ionic component in the formed plasma to the substrate W.

In one embodiment, the RF power source 133a includes a first RF generator 133a1 and a second RF generator 133a2. The first RF generator 133a1 is coupled to at least one lower electrode and/or at least one upper electrode via the at least one impedance matching circuit, and is configured to generate a plasma generation source RF signal (source RF power). In one embodiment, the source RF signal has a frequency within a range from 10 MHz to 150 MHz. In one embodiment, the first RF generator 133a1 may be configured to generate a plurality of source RF signals having different frequencies. The generated one or more source RF signals are supplied to at least one lower electrode and/or at least one upper electrode.

The second RF generator 133a2 is coupled to the at least one lower electrode via the at least one impedance matching circuit and is configured to generate the bias RF signal (bias RF power). A frequency of the bias RF signal may be the same as or different from a frequency of the source RF signal. In one embodiment, the bias RF signal has a frequency lower than the frequency of the source RF signal. In one embodiment, the bias RF signal has a frequency within a range from 100 kHz to 60 MHz. In one embodiment, the second RF generator 133a2 may be configured to generate a plurality of bias RF signals having different frequencies. The generated one or more bias RF signals are supplied to the at least one lower electrode. Further, in various embodiments, at least one of the source RF signal and the bias RF signal may be pulsed.

The power source 133 may include a DC power source 133b coupled to the plasma processing chamber 110. The DC power source 133b includes a first DC generator 133b1 and a second DC generator 133b2. In one embodiment, the first DC generator 133b1 is connected to at least one lower electrode and is configured to generate a first DC signal. The generated first DC signal is applied to at least one lower electrode. In one embodiment, the second DC generator 133b2 is connected to at least one upper electrode and is configured to generate a second DC signal. The generated second DC signal is applied to the at least one upper electrode.

In one or more embodiments, the first and second DC signals may be pulsed. In this case, a sequence of voltage pulses is applied to at least one lower electrode and/or at least one upper electrode. The voltage pulses may each have a rectangular, trapezoidal, or triangular pulse waveform or a combination thereof. In one or more embodiments, a waveform generator for generating the sequence of voltage pulses from a DC signal is connected between the first DC generator 133b1 and at least one lower electrode. Accordingly, the first DC generator 133b1 and the waveform generator form a voltage pulse generator. When the second DC generator 133b2 and the waveform generator form the voltage pulse generator, the voltage pulse generator is connected to at least one upper electrode. The voltage pulse may have a positive polarity or a negative polarity. The sequence of the voltage pulses may include one or more positive voltage pulses and one or more negative voltage pulses in one cycle. The first and second DC generators 133b1 and 133b2 may be provided in addition to the RF power source 133a, and the first DC generator 133b1 may be provided instead of the second RF generator 133a2.

In the illustrated example, a case where the plasma processing module 60 includes the capacitively-coupled plasma (CCP) plasma generator 130 is illustrated as an example. However, the configuration of the plasma generator is not limited thereto, and may be inductively-coupled plasma (ICP), electron-cyclotron-resonance plasma (ECR plasma), helicon wave plasma (HWP), surface wave plasma (SWP), or the like. Further, various types of plasma generators, including an alternating current (AC) plasma generator and a direct current (DC) plasma generator, may be used. In one embodiment, an AC signal (AC power) used by the AC plasma generator has a frequency in a range of 100 kHz to 10 GHz. Accordingly, the AC signal includes a radio frequency (RF) signal and a microwave signal. In one embodiment, the RF signal has a frequency in a range of 100 kHz to 150 MHz.

The exhaust system 140 may be connected, for example, to a gas exhaust port 110e disposed at a bottom of the plasma processing chamber 110. The exhaust system 140 may include a pressure adjusting valve and a vacuum pump. Pressure inside the plasma processing space 110s is adjusted by the pressure adjusting valve. The vacuum pump may include a turbo molecular pump, a dry pump, or a combination thereof.

Returning to the description of the plasma processing system.

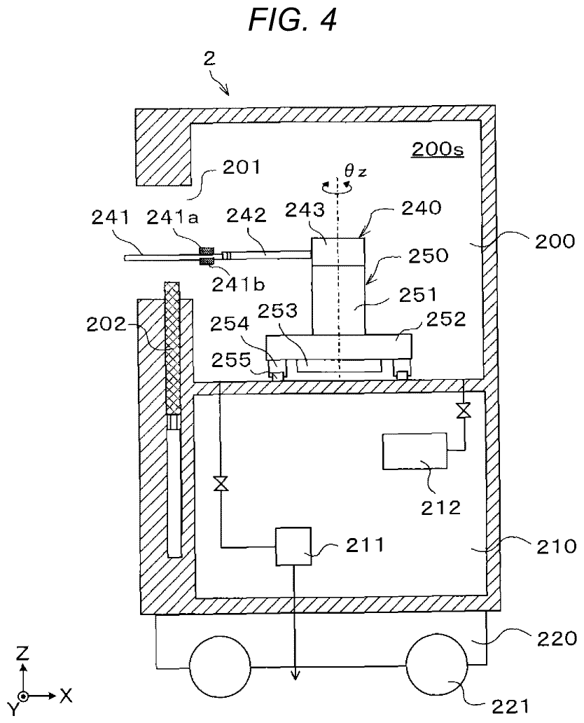

The mobile replacement apparatus 2 stores the consumable component before use such as the ring assembly 122 therein, and replaces the ring assembly 122 before use with the ring assembly 122 after use in the plasma processing module 60. As illustrated in FIG. 4, the mobile replacement apparatus 2 includes an upper chamber 200, a lower chamber 210, and a moving mechanism 220. The moving mechanism 220, the lower chamber 210, and the upper chamber 200 are stacked in this order.

As illustrated in FIGS. 1 and 4, the upper chamber 200 includes the component transfer port 201 connected to the second surface 110b of the plasma processing chamber 110 and a gate valve 202 that opens and closes the component transfer port 201. In addition, as illustrated in FIG. 1, the upper chamber 200 is provided with an opening 203 connected to a component storage portion 230 that stores a plurality of consumable components such as the ring assembly 122 and the shower head 131, and a gate valve 204 that opens and closes the opening 203. Accordingly, the mobile replacement apparatus 2 is connected to the plasma processing chamber 110 of the plasma processing module 60 via the second surface 110b, and the plasma processing space 110s and a replacement space 200s inside the upper chamber 200 communicate with each other through the component transfer port 201.

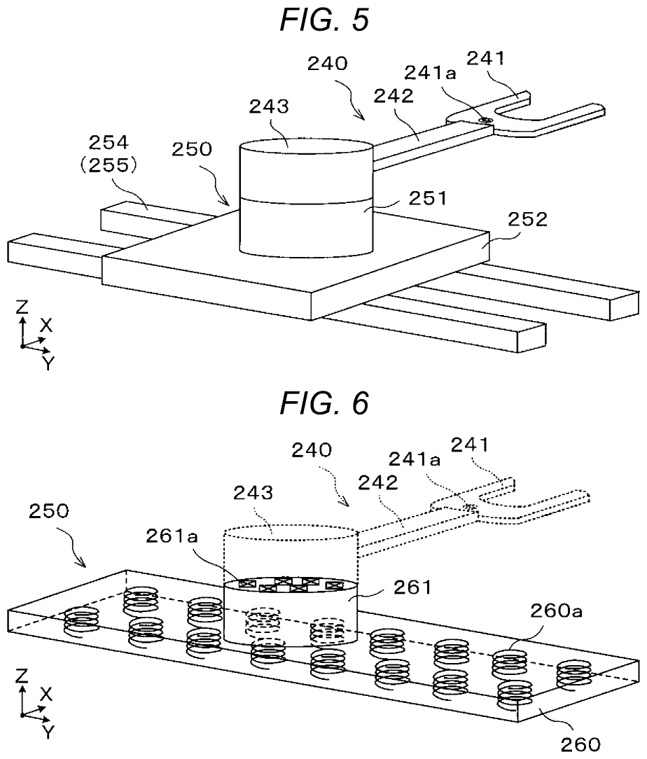

The component replacement robot 240 for transferring the ring assembly 122 or the like that is the consumable component is provided inside the upper chamber 200. The component replacement robot 240 includes the end effector 241 that holds and transfers the consumable component, an extending and retracting mechanism 242 that moves the end effector 241 in an axial direction (a longitudinal direction, which is the X-axis direction in examples shown in FIGS. 4 and 5), and a base portion 243. The extending and retracting mechanism 242 has one end connected to the end effector 241 and the other end connected to the base portion 243. The component replacement robot 240 is configured to transfer the consumable component between the component storage portion 230 and the plasma processing module 60.

The end effector 241 holds and transfers the consumable member as described above. As shown in FIGS. 4 and 5, an upper surface and a lower surface of the end effector 241 are provided with a first position detection sensor 241a and a second position detection sensor 241b, respectively. The first and second position detection sensors 241a and 241b are, for example, displacement meters. By providing these first and second position detection sensors 241a and 241b, the component replacement robot 240 can detect a relative horizontal position of the consumable component relative to the support member 120 in the plasma processing module 60.

As described above, the extending and retracting mechanism 242 can move the end effector 241 in an extending and retracting direction with respect to the base portion 243. A configuration of the extending and retracting mechanism 242 is not particularly limited as long as the end effector 241 can be moved in the extending and retracting direction. Specifically, for example, a known mechanism such as a linear guide or a linear bushing can be adopted for the extending and retracting mechanism 242.

When the extending and retracting mechanism 242 is a linear guide, the extending and retracting mechanism 242 includes a rail (not illustrated) extending along the X-axis direction (second rail) and a slider (not illustrated) moving along the rail (second slider).

When the extending and retracting mechanism 242 is a linear bushing, the extending and retracting mechanism 242 includes a shaft (not illustrated) extending along the X-axis direction (second shaft) and a cylinder (not illustrated) moving along the shaft (second cylinder).

Alternatively, similar to the transfer robot 70, the extending and retracting mechanism 242 may be implemented by a horizontal articulated arm (link arm) structure in which a plurality of, for example, three arms are connected, and thus the end effector 241 can be freely moved in the extending and retracting direction with respect to the base portion 243. In addition, the extending and retracting mechanism 242 may be mechanically driven using a motor, air, or the like, or may be implemented with only a guide mechanism as a structure to be manually operated.

Accordingly, when the mobile replacement apparatus 2 is connected to the second surface 110b of the plasma processing module 60, the component replacement robot 240 transfers the consumable component held by the end effector 241 along the first direction (the X-axis direction in the embodiment) orthogonal to the second surface 110b.

As shown in FIG. 5, the component replacement robot 240 is disposed in a stacked manner on the slide mechanism 250 in the replacement space 200s. The slide mechanism 250 includes a base 251, a slider table 252, a rotation mechanism 253, a moving mechanism 254, and a rail 255.

The base portion 243 of the component replacement robot 240 is supported at the slider table 252 via the base 251. The slider table 252 is provided with the rotation mechanism 253. The rotation mechanism 253 includes, for example, a motor therein as a drive source. The component replacement robot 240 is rotatable about a vertical axis (Oz axis) by the rotation mechanism 253 via the base 251. The slider table 252 is movable, via the moving mechanism 254 provided on a lower surface side thereof, on the rail 255 extending in the Y-axis direction in the replacement space 200s of the upper chamber 200.

Accordingly, it can be said that the end effector 241 is rotatable about the vertical axis by the rotation mechanism 253 via the base portion 243 and is movable in the longitudinal direction by the extending and retracting mechanism 242, and that the component replacement robot 240 can freely transfer the consumable component in a so-called polar coordinate plane.

As described above, the slide mechanism 250 allows the component replacement robot 240 to move freely on the slider table 252 along the Y-axis direction. A configuration of the slide mechanism 250 is not particularly limited as long as the component replacement robot 240 can be moved along the Y-axis direction. Specifically, for example, a known mechanism such as a linear guide or a linear bushing can be adopted for the slide mechanism 250.

When the slide mechanism 250 is a linear guide, the slide mechanism 250 includes a rail 255 extending along the Y-axis direction and a moving mechanism 254 (slider) attached to the component replacement robot 240 via the base 251 and moving along the rail 255, as shown in FIG. 5.

When the slide mechanism 250 is a linear bushing, the slide mechanism 250 includes a shaft (not illustrated) extending along the Y-axis direction and a cylinder (not illustrated) attached to the component replacement robot 240 via the base 251 and moving along the shaft. At this time, the slide mechanism 250 may be mechanically driven using a motor, air, or the like, or may be implemented with only a guide mechanism as a structure to be manually operated. In addition, as the slide mechanism 250, a transfer device for transferring a transfer target object by magnetic levitation disclosed in JP2022-133867A may be adopted.

FIG. 6 illustrates an example of a configuration of the slide mechanism 250 when the component replacement robot 240 is moved in the Y-axis direction by magnetic levitation. As shown in FIG. 6, the slide mechanism 250 includes a planar motor 260 and a transfer unit 261 (i.e., transferer).

In the planar motor 260, a plurality of coils 260a are arranged along the Y-axis direction, which is a slide direction of the component replacement robot 240. The coils 260a generate a magnetic field when being supplied with a current from a power source (not illustrated). It is desirable that power supplied to each of the plurality of coils 260a is independently controllable under control of the controller 3 to be described later, for example.

The transfer unit 261 is formed in, for example, a cylindrical shape. The base portion 243 of the component replacement robot 240 is connected to an upper surface of the transfer unit 261. In addition, a plurality of permanent magnets 261a are arranged in the transfer unit 261. The transfer unit 261 is magnetically levitated on the planar motor 260 by the magnetic field generated by the coils 260a. A levitation amount of the transfer unit 261 with respect to the planar motor 260 can be controlled by a value of the current to be supplied to the coils 260a. In addition, the transfer unit 261 moves and rotates on the planar motor 260 due to the magnetic field generated by the coils 260a.

With this configuration, the slide mechanism 250 controls the value of the current to be supplied to each coil 260a under control of the controller 3 and moves the component replacement robot 240 along the Y-axis direction.

Accordingly, the component replacement robot 240 is configured to slide the end effector 241 along a second direction (the Y-axis direction that is an extension direction of the second surface 110b when the mobile replacement apparatus 2 is connected to the second surface 110b of the plasma processing module 60 in the embodiment) orthogonal to the first direction (the X-axis direction in the embodiment).

An exhaust system 211 and a gas supply system 212 are provided inside the lower chamber 210. The exhaust system 211 and the gas supply system 212 are connected to the replacement space 200s inside the upper chamber 200. In the mobile replacement apparatus 2, pressure inside the replacement space 200s can be adjusted by operations of the exhaust system 211 and the gas supply system 212.

The mobile replacement apparatus 2 is movable by the moving mechanism 220 to the front of any plasma processing module 60 whose consumable component is to be replaced. In an example, the moving mechanism 220 is provided with wheels 221, a power source such as a battery, a drive source, and a steering mechanism as illustrated in FIG. 4, and the configuration of the moving mechanism 220 is not particularly limited as long as the mobile replacement apparatus 2 can be moved. The mobile replacement apparatus 2 is moved to the front of any plasma processing module 60 by the moving mechanism 220 in this way, then is connected to the second surface 110b of the plasma processing module 60, and then the consumable component is replaced.

The plasma processing system described above includes the controller 3 as described above. The controller 3 processes computer-executable instructions that cause the plasma processing system to execute various steps described in the disclosure. The controller 3 may be configured to control the elements of the plasma processing system to execute various steps described herein. In one embodiment, a part or all of the controllers 3 may be provided in the plasma processing system. The controller 3 may include a processor 3a1, a storage 3a2, and a communication interface 3a3. The controller 3 is implemented by, for example, a computer 3a. The processor 3a1 may read a program from the storage 3a2 and perform various control operations by executing the read program. The program may be stored in advance in the storage 3a2 or may be acquired via a medium when necessary. The acquired program is stored in the storage 3a2, read from the storage 3a2 by the processor 3a1 and executed. The medium may be various recording media readable by the computer 3a, or may be a communication line connected to the communication interface 3a3. The processor 3a1 may be a central processing unit (CPU). The storage 3a2 may include a random access memory (RAM), a read only memory (ROM), a hard disk drive (HDD), a solid state drive (SSD), or a combination thereof. The communication interface 3a3 may communicate with the plasma processing system via a communication line such as a local area network (LAN). Further, the storage medium may be temporary or non-temporary medium.

The plasma processing system according to the embodiment is implemented as described above. Next, a component replacement sequence performed using the plasma processing system will be described. In an example, the component replacement sequence is performed under control of the controller 3. In the following description, an example will be described in which the consumable component to be replaced in the component replacement sequence is the ring assembly 122.

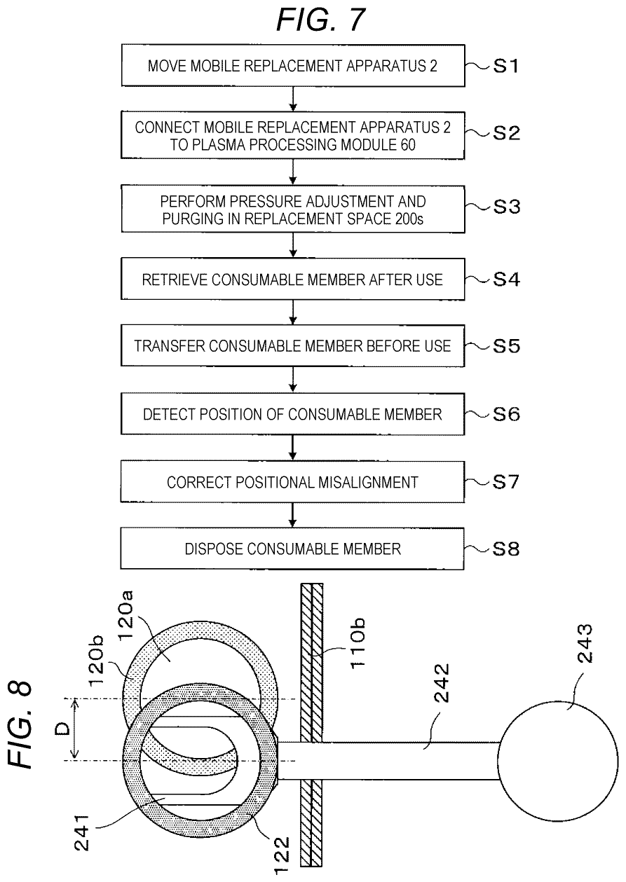

In the component replacement sequence, first, the mobile replacement apparatus 2 is moved by the moving mechanism 220 to the front of the plasma processing module 60 whose ring assembly 122 is to be replaced (step S1 in FIG. 7).

Next, the mobile replacement apparatus 2 is connected to the second surface 110b of the plasma processing module 60 (step S2 in FIG. 7). The mobile replacement apparatus 2 is connected to the plasma processing module 60 using, for example, a fastening member or the like after a relative horizontal position of the mobile replacement apparatus 2 relative to the plasma processing module 60 is determined using, for example, a positioning pin.

Next, in a state where the gate valve 202 of the upper chamber 200 is closed and the plasma processing space 110s and the replacement space 200s are separated, pressure adjustment and purging in the replacement space 200s are performed (step S3 in FIG. 7). When the pressure inside the replacement space 200s substantially coincides with the pressure inside the plasma processing space 110s whose ring assembly 122 is to be replaced, the gate valve 202 of the upper chamber 200 and the gate valve 112 of the plasma processing chamber 110 are opened to establish communication between the plasma processing space 110s and the replacement space 200s.

When the plasma processing space 110s and the replacement space 200s communicate with each other, the ring assembly 122 after use in the plasma processing module 60 is then retrieved (step S4 in FIG. 7).

Specifically, first, each ring lift pin 123a is lifted from the standby position H2 to the transfer position H1, and the ring assembly 122 after use supported by the ring support surface of the support member 120 is lifted on the ring support surface.

Subsequently, the end effector 241 of the mobile replacement apparatus 2 is moved into the plasma processing space 110s by the extending and retracting mechanism 242 and inserted below the ring assembly 122 after use lifted by the ring lift pin 123a.

Subsequently, the ring lift pin 123a is lowered from the transfer position H1 to the standby position H2, and accordingly, the ring assembly 122 after use is transferred from the ring lift pin 123a to the end effector 241 of the mobile replacement apparatus 2.

Finally, the end effector 241 holding the ring assembly 122 after use is moved to the replacement space 200s, and then the ring assembly 122 after use is transferred to the component storage portion 230 to complete retrieval of the ring assembly 122 after use.

Next, the ring assembly 122 before use is transferred into the plasma processing module 60 (step S5 in FIG. 7).

Specifically, first, the end effector 241 of the component replacement robot 240 enters the component storage portion 230 to hold the ring assembly 122 before use.

Subsequently, the end effector 241 holding the ring assembly 122 before use enters the plasma processing space 110s, and thus the ring assembly 122 before use can be transferred into the plasma processing module 60.

At this time, a position of the ring assembly 122 before use in the plasma processing module 60 is detected based on measurement results from the first and second position detection sensors 241a and 241b provided at the end effector 241 of the component replacement robot 240 (step S6 in FIG. 7).

As an example, the first position detection sensor 241a disposed at the upper surface of the end effector 241 detects the position of the ring assembly 122 before use, and the second position detection sensor 241b disposed at the lower surface of the end effector 241 detects a position of the support member 120. By combining the positions of the ring assembly 122 before use and the support member 120 obtained from the measurement results from the first and second position detection sensors 241a and 241b, a relative horizontal position of the ring assembly 122 before use relative to the support member 120 can be detected.

Here, since the mobile replacement apparatus 2 and the plasma processing module 60 are repeatedly attached and detached each time parts are replaced, positional misalignment between the mobile replacement apparatus 2 and the plasma processing module 60 in the horizontal direction (the Y-axis direction that is the extension direction of the second surface 110b) may occur due to docking (step S2) as described above. Due to such positional misalignment, a relationship between relative horizontal positions of the support member 120 and the end effector 241 in the plasma processing module 60, in other words, a relationship between a replacement position (planned placement position) of the ring assembly 122 and a transfer position by the end effector 241 becomes uncertain.

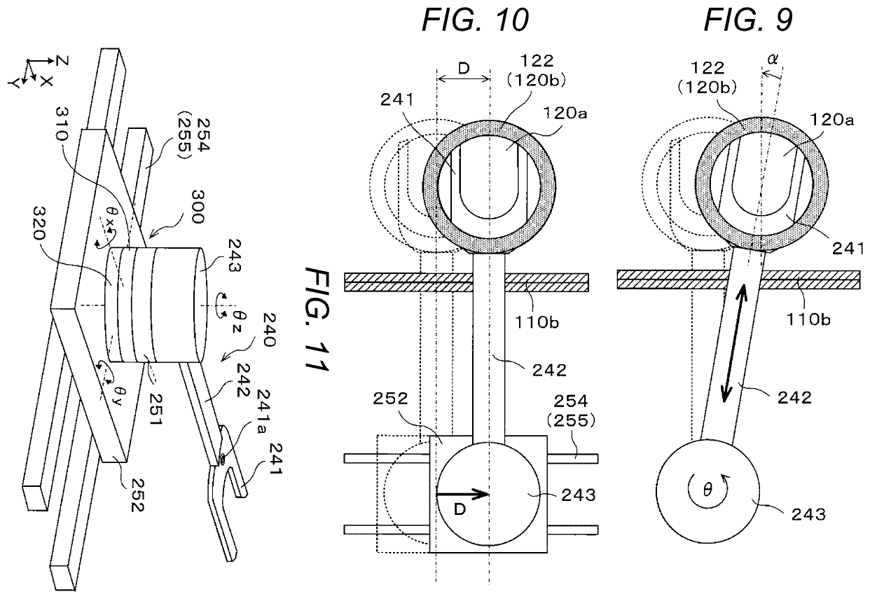

Therefore, in step S6 described above, relative horizontal positional misalignment D may be detected between the ring assembly 122 and the support member 120 as shown in FIG. 8. When the end effector 241 is moved using only the extending and retracting mechanism 242 and the rotation mechanism 253 to correct the positional misalignment D in a state where the positional misalignment D occurs between the ring assembly 122 and the support member 120 in this way, the ring assembly 122 is placed with a misalignment of an angle α in a rotational direction with respect to the support member 120 as shown in FIG. 9.

In related art, when the ring assembly 122 is placed in a misaligned manner in the rotational direction with respect to the support member 120 in this way, it is required to return the ring assembly 122 to the component storage portion 230 once, rotate the ring assembly 122 by the angle α using an orienter provided in the component storage portion 230, and then transfer the ring assembly 122 to the plasma processing module 60 again. Therefore, when the docking misalignment occurs between the mobile replacement apparatus 2 and the plasma processing module 60, it takes a long time to load the ring assembly 122 before use.

In this respect, in the plasma processing system according to the technique of the disclosure, even when the horizontal positional misalignment D occurs between the mobile replacement apparatus 2 and the plasma processing module 60, it is possible to correct misalignment (angle α) in the rotational direction of the ring assembly 122 without returning the ring assembly 122 to the component storage portion 230 (step S7 in FIG. 7: positional misalignment correction).

Specifically, in the technique according to the disclosure, when the relative horizontal positional misalignment D is detected between the ring assembly 122 and the support member 120 in step S6, the positional misalignment D is corrected simply by moving the entire component replacement robot 240 in the horizontal direction by the positional misalignment D using the slide mechanism 250, as shown in FIG. 10.

In this way, according to the technique of the disclosure, since the positional misalignment correction can be performed simply by moving the component replacement robot 240 in the horizontal direction by the slide mechanism 250 without using the rotation mechanism 253, the misalignment in the rotational direction with respect to the support member 120 does not occur in the ring assembly 122. Therefore, the positional misalignment can be corrected without returning the ring assembly 122 to the component storage portion 230, and thus a time required for loading the ring assembly 122 before use can be significantly shortened.

When the positional misalignment of the ring assembly 122 with respect to the support member 120 is corrected, the ring assembly 122 before use is then placed on the ring support surface of the support member 120 (step S8 in FIG. 7).

Specifically, first, the ring lift pin 123a is lifted from the standby position H2 to the transfer position H1, and accordingly, the ring assembly 122 before use is transferred from the end effector 241 to the ring lift pin 123a.

Subsequently, the end effector 241 is retracted into the replacement space 200s of the mobile replacement apparatus 2 by the extending and retracting mechanism 242.

Finally, the ring lift pin 123a holding the ring assembly 122 before use is lowered from the transfer position H1 to the standby position H2, and accordingly, the ring assembly 122 on the ring lift pin 123a is placed on the ring support surface.

When the ring assembly 122 is placed on the ring support surface, a series of the component replacement sequence is completed.

As described above, according to the plasma processing system according to the technique of the disclosure, even when the positional misalignment due to the docking (step S2) occurs between the mobile replacement apparatus 2 and the plasma processing module 60 whose consumable component is to be replaced, such positional misalignment can be corrected by the slide mechanism 250, and the consumable component can be transferred to a desired position without causing misalignment in the rotational direction.

By disposing the slide mechanism 250 below the component replacement robot 240 in this way, the positional misalignment correction can be performed using only this slide mechanism 250, and thus it is not required to modify the component replacement robot 240 used in the related art, and a size increase in the configuration of the mobile replacement apparatus 2 can be prevented.

As described above, since the positional misalignment correction can be performed without returning the consumable component to the component storage portion 230 using the slide mechanism 250, a time required for the series of the component replacement sequence can be significantly shortened. At the same time, it is not required to correct the misalignment in the rotational direction by the orienter in the component storage portion 230. Accordingly, it is not necessary to dispose the orienter in the mobile replacement apparatus 2, and thus a size of the configuration of the mobile replacement apparatus 2 can be reduced or the number of components stored in the component storage portion 230 can be increased.

Further, according to the technique of the present disclosure, by providing the first and second position detection sensors 241a and 241b at the component replacement robot 240 of the mobile replacement apparatus 2, a position of the consumable component can be appropriately detected when the consumable component is transferred to the plasma processing module 60. Therefore, in addition to the positional misalignment caused by the docking misalignment described above, for example, even when the positional misalignment occurs due to load deformation when the end effector 241 holds the consumable component, the position of the consumable component can be detected based on the position detection sensors and the positional misalignment correction can be performed to allow the consumable component to be more appropriately transferred to the desired position.

Further, in the plasma processing system according to the present application, it is not required to expose the plasma processing module 60 to the atmosphere when replacing the consumable component. Therefore, the replacement of the consumable component can be performed under reduced pressure (vacuum) or in a dry environment, and a vacuuming time after replacement of parts or a mean time between cleanings (MTBC) can be shortened.

Accordingly, according to the technique of the disclosure, a module that includes the consumable component to be replaced is not limited to a module that performs processing on the substrate W under reduced pressure as the plasma processing module 60 described above, and any substrate processing module can be selected.

Further, according to the disclosure, the component replacement sequence can be completed only by the mobile replacement apparatus 2 and the plasma processing module 60 without the vacuum transfer module 50. Therefore, it is not required to bring the consumable component after use into the vacuum transfer module 50, and thus contamination of the vacuum transfer module 50 can be prevented. In addition, the transfer arm 71 of the vacuum transfer module 50 is not used for retrieving the consumable component after use, and thus an influence on a process in another plasma processing module 60 can be reduced.

The above embodiment has been described using an example in which the consumable component to be replaced is the ring assembly 122 (cover ring or focus ring), and the type of the consumable component is not limited thereto. Specifically, for example, the shower head 131 described above or a deposition shield for preventing deposition from adhering to the sidewall of the plasma processing chamber 110 may be replaced as the consumable component by the mobile replacement apparatus 2.

For example, a second chamber for facilitating maintenance of the plasma processing chamber 110, more specifically, a second chamber disposed inside the plasma processing chamber 110 to define a processing space in the plasma processing chamber 110 as disclosed in JP2022-8057A may be replaced as the consumable component by the mobile replacement apparatus 2.

In this way, even in a case where another consumable component is replaced, when the consumable component is transferred to the plasma processing module 60, the consumable component can be appropriately transferred to the desired position by performing the positional misalignment correction using the slide mechanism 250.

In the plasma processing system according to the technique of the disclosure, in addition to the configuration of the slide mechanism 250 described above, an adjustment mechanism for rotating the end effector 241 of the component replacement robot 240 about a horizontal axis may be further provided.

FIG. 11 is a perspective view illustrating a schematic configuration of a slide mechanism 300 according to another embodiment, which includes first and second adjustment mechanisms 310 and 320 for rotating the end effector 241 about the horizontal axis. In the slide mechanism 300, elements having substantially the same configurations as those of the slide mechanism 250 described in the above embodiment are denoted by the same reference numerals, and a detailed description thereof will be omitted.

As shown in FIG. 11, the slide mechanism 300 includes the first adjustment mechanism 310 and the second adjustment mechanism 320. The first and second adjustment mechanisms 310 and 320 are disposed in a stacked manner with the base 251 below the base portion 243 of the component replacement robot 240. The base 251 may be omitted as appropriate. In this case, the base portion 243 of the component replacement robot 240 is connected to the first adjustment mechanism 310 or the second adjustment mechanism 320. In addition, such first and second adjustment mechanisms 310 and 320 may be separated from the rotation mechanism 253 as shown in FIG. 11, or may be integrated with the rotation mechanism 253, for example, using a gimbal or any other known mechanism.

The first adjustment mechanism 310 rotates the component replacement robot 240 about a θx axis with respect to an extension direction (X-axis direction) of the component replacement robot 240 (extending and retracting mechanism 242) via the base 251.

The second adjustment mechanism 320 rotates the component replacement robot 240 about a θy axis with respect to an extension direction (Y-axis direction) of the rail 255 via the base 251.

Accordingly, the first adjustment mechanism 310, which is a first rotation mechanism rotates the component replacement robot 240 in the first direction orthogonal to the second surface 110b when the mobile replacement apparatus 2 is connected to the second surface 110b of the plasma processing module 60.

Accordingly, the second adjustment mechanism 320, which is a second rotation mechanism, rotates the component replacement robot 240 in the second direction orthogonal to the first direction.

In addition, the rotation mechanism 253, which is a third rotation mechanism, rotates the component replacement robot 240 in the horizontal direction about a vertical axis. The horizontal direction being orthogonal to the first direction and the second direction. Further, each of the first direction, second direction and the third direction are orthogonal to each other. Each of the first rotation mechanism 310, the second rotation mechanism 320 and the third rotation mechanism 253 may include a motor (i.e., an electrical motor) or the like to allow for the rotation of the component replacement robot 240.

In this way, by allowing the component replacement robot 240 to rotate axially along the X-axis direction and the Y-axis direction by the first and second adjustment mechanisms 310 and 320, in addition to correcting the positional misalignment in the Y-axis direction described above, even when the consumable component is tilted from the horizontal due to, for example, docking between the plasma processing module 60 and the mobile replacement apparatus 2 or holding of the consumable component by the end effector 241, the consumable component can be kept horizontal and appropriately transferred onto the support member 120.

As shown in FIG. 6, when the slide mechanism 250 moves the component replacement robot 240 along the Y-axis direction by magnetic levitation, for example, the value of the current to be supplied to each coil 260a is controlled, and accordingly, the levitation amount of the component replacement robot 240 is changed for each coil 260a, and thus the same effects as those of the first and second adjustment mechanisms 310 and 320 can be obtained. In other words, when the slide mechanism 250 moves the component replacement robot 240 by magnetic levitation, the slide mechanism 250 implements the first and second adjustment mechanisms 310 and 320.

In the component replacement robot 240 according to the embodiment described above, the slide mechanism 250 is disposed below the base portion 243 to move the component replacement robot 240 in the horizontal direction along the Y-axis direction. However, the configuration and disposition of the slide mechanism are not limited thereto as long as at least the consumable component held by the end effector 241 can be moved in the horizontal direction with respect to the support member 120.

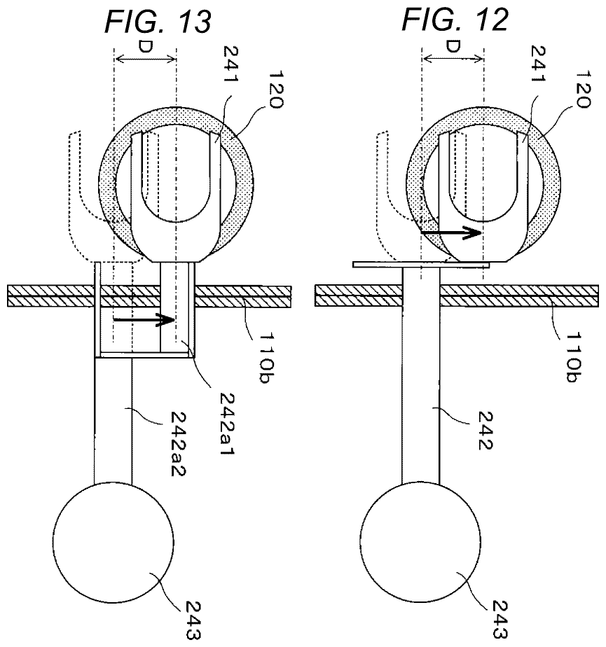

Specifically, for example, as shown in FIG. 12, a configuration may be adopted in which only the end effector 241 is movable in the horizontal direction with respect to the extending and retracting mechanism 242. Alternatively, as shown in FIG. 13, a configuration may be adopted in which the extending and retracting mechanism 242 includes a plurality of arms 242a divided in an axial direction and one arm 242a1 connected to the end effector 241 is movable in the horizontal direction along the Y-axis direction with respect to another arm 242a2 connected to another end of the one arm 242a1.

It shall be understood that the embodiments disclosed herein are illustrative and are not restrictive in all aspects. The embodiment described above may be omitted, replaced, or modified in various forms without departing from the scope and spirit of the appended claims. For example, the components of the embodiments described above may be combined as desired. From the desired combination, functions and effects of each component related to the combination can be obtained as a matter of course, and other functions and effects apparent to those skilled in the art can be obtained from the description herein.

The effects described herein are merely illustrative or exemplary, and are not limited. In other words, the technique according to the present disclosure may have other effects apparent to those skilled in the art from the description herein, in addition to or in place of the effects described above. The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

1. A cluster tool comprising:
a plasma processing apparatus; and
a mobile replacement apparatus, wherein
the plasma processing apparatus includes:
a plasma processing module having a first surface and a second surface, and
a vacuum transferer connected to the plasma processing module via the first surface, and
the plasma processing module includes:
a support member having a substrate support surface and a ring support surface; and
a consumable ring disposed on the ring support surface, and
the mobile replacement apparatus includes:
a ring storage portion configured to store the consumable ring;
a ring replacement robot configured to transfer the consumable ring along a first direction between the ring storage portion and the plasma processing module, the first direction being orthogonal to the second surface when the mobile replacement apparatus is connected to the plasma processing module; and
a slide mechanism configured to slide the ring replacement robot along a second direction orthogonal to the first direction.

2. The cluster tool according to claim 1, wherein
the slide mechanism includes:
a rail extending along the second direction; and
a slider attached to the ring replacement robot and configured to move along the rail.

3. The cluster tool according to claim 1, wherein
the slide mechanism includes:
a shaft extending along the second direction; and
a cylinder attached to the ring replacement robot and configured to move along the shaft.

4. The cluster tool according to claim 1, wherein
the slide mechanism includes:
a planar motor including a plurality of coils arranged along the second direction; and
a transferer attached to the ring replacement robot and configured to move along the second direction in a state of being levitated above the planar motor by a magnetic field generated by the plurality of coils.

5. The cluster tool according to claim 4, further comprising:
circuitry configured to independently control a current to be supplied to each of the plurality of coils.

6. The cluster tool according to claim 1, wherein
the ring replacement robot has a horizontal articulated arm structure for moving the consumable ring along the first direction.

7. The cluster tool according to claim 1, wherein
the ring replacement robot includes:
a second rail extending along the first direction; and
a second slider configured to move along the second rail.

8. The cluster tool according to claim 1, wherein
the ring replacement robot includes:
a second shaft extending along the first direction; and
a second cylinder configured to move along the second shaft.

9. The cluster tool according to claim 1, further comprising:
a first rotation mechanism configured to axially rotate the ring replacement robot with respect to the first direction.

10. The cluster tool according to claim 9, further comprising:
a second rotation mechanism configured to axially rotate the ring replacement robot with respect to the second direction.

11. The cluster tool according to claim 10, further comprising:
a third rotation mechanism configured to rotate the ring replacement robot in a horizontal direction.

12. A cluster tool comprising:
a substrate processing apparatus; and
a mobile replacement apparatus, wherein
the substrate processing apparatus includes a consumable component, and
the mobile replacement apparatus includes:
a component storage portion configured to store the consumable component;
a component replacement robot configured to transfer the consumable component along a first direction between the component storage portion and the substrate processing apparatus, the first direction being orthogonal to a connection surface between the mobile replacement apparatus and the substrate processing apparatus when the mobile replacement apparatus is connected to the substrate processing apparatus; and
a slide mechanism configured to slide the component replacement robot along a second direction orthogonal to the first direction.

13. The cluster tool according to claim 12, wherein
the slide mechanism includes:
a rail extending along the second direction; and
a slider attached to the component replacement robot and configured to move along the rail.

14. The cluster tool according to claim 12, wherein
the slide mechanism includes:
a shaft extending along the second direction; and
a cylinder attached to the component replacement robot and configured to move along the shaft.

15. The cluster tool according to claim 12, wherein
the slide mechanism includes:
a planar motor including a plurality of coils arranged along the second direction; and
a transferer attached to the component replacement robot and configured to move along the second direction in a state of being levitated above the planar motor by a magnetic field generated by the plurality of coils.

16. A cluster tool comprising:
a substrate processing apparatus; and
a mobile replacement apparatus, wherein
the substrate processing apparatus includes a consumable component, and
the mobile replacement apparatus includes:
a component storage portion configured to store the consumable component;
a component replacement robot including a base portion and an end effector configured to transfer the consumable component, the end effector being configured to move along a first direction between the component storage portion and the substrate processing apparatus, the first direction being orthogonal to a connection surface between the mobile replacement apparatus and the substrate processing apparatus when the mobile replacement apparatus is connected to the substrate processing apparatus; and
a slide mechanism configured to slide the end effector with respect to the base portion along a second direction orthogonal to the first direction.

17. The cluster tool according to claim 16, wherein
the component replacement robot further includes an extending and retracting mechanism attached to the base portion and configured to move the end effector along the first direction, and
the slide mechanism slides the end effector along the second direction with respect to the extending and retracting mechanism.

18. The cluster tool according to claim 16, wherein
the component replacement robot further includes an extending and retracting mechanism attached to the base portion and configured to move the end effector along the first direction,
the extending and retracting mechanism includes a first arm and a second arm,
the first arm is connected to the end effector, and
the slide mechanism slides the first arm along the second direction with respect to the second arm.

19. The cluster tool according to claim 16, wherein the slide mechanism includes a planar motor including a plurality of coils arranged along the second direction, and a transferer configured to move along the second direction in a state of being levitated above the planar motor by a magnetic field generated by the plurality of coils, the transferer being configured to slide the end effector with respect to the base portion.

20. The cluster tool according to claim 19, further comprising: a controller configured to independently control a current to be supplied to each of the plurality of coils.
